(19) United States
(12) Patent Application Publication
(10) Pub. No.: US 2020/0402020 A1
(43) Pub. Date: Dec. 24, 2020

(54) FOCUS TIME AUTO BOOKING

(71) Applicant: Microsoft Technology Licensing, LLC, Redmond, WA (US)

(72) Inventors: Peter Burton Bergen, Seattle, WA (US); Wendy Guo, Edmund, WA (US); Noelle Renee Beaujon, Seattle, WA (US); Charu Kwatra, Redmond, WA (US)

(21) Appl. No.: 16/444,163

(22) Filed: Jun. 18, 2019

(51) Int. Cl. G06Q 10/10; G06F 16/9535; G06F 16/2458

(52) U.S. Cl. CPC G06Q 10/1095; G06F 16/2477; G06F 16/9535

(57) ABSTRACT

A system and method for updating calendar data is described. A server accesses calendar data for a user account and parses the calendar data for a plurality of available time slots within an upcoming timeframe. The server schedules a focus time session for a corresponding available time slot of the plurality of available time slots within the upcoming timeframe in the calendar data. A confirmation of the scheduled focus time sessions is provided to the user account.

### BACKGROUND

The subject matter disclosed herein generally relates to a special-purpose machine that updates calendar data for a user account, including computerized variants of such special-purpose machines and improvements to such variants. Specifically, the present disclosure addresses systems and methods for an interactive tool to book focus time using a calendar application.

Many knowledge workers now spend most of their week in collaborative activity (emails, meetings, instant messages). Knowledge workers now face increasing challenge when having to perform non-routine tasks that require concentration: (1) distractions caused by digital interruptions (including desktop and mobile notifications for work emails and chats); and (2) calendar fragmentation caused by meeting proliferation. Both phenomena can inhibit knowledge workers' ability to perform cognitively-challenging work. Some studies have found that it can take up to 23 minutes to return to a given task after a single interruption, and that people who experience interruptions report higher levels of stress and frustration.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a focus time engine in accordance with one example embodiment.

FIG. 3 is a block diagram illustrating a focus time tool in accordance with one example embodiment.

FIG. 4 is a flow diagram illustrating a method for scheduling focus time in accordance with one example embodiment.

FIG. 5 is a flow diagram illustrating a method for confirming focus time in accordance with one example embodiment.

FIG. 6 is a flow diagram illustrating a method for scheduling focus time in accordance with one example embodiment.

FIG. 7 illustrates a routine in accordance with one embodiment.

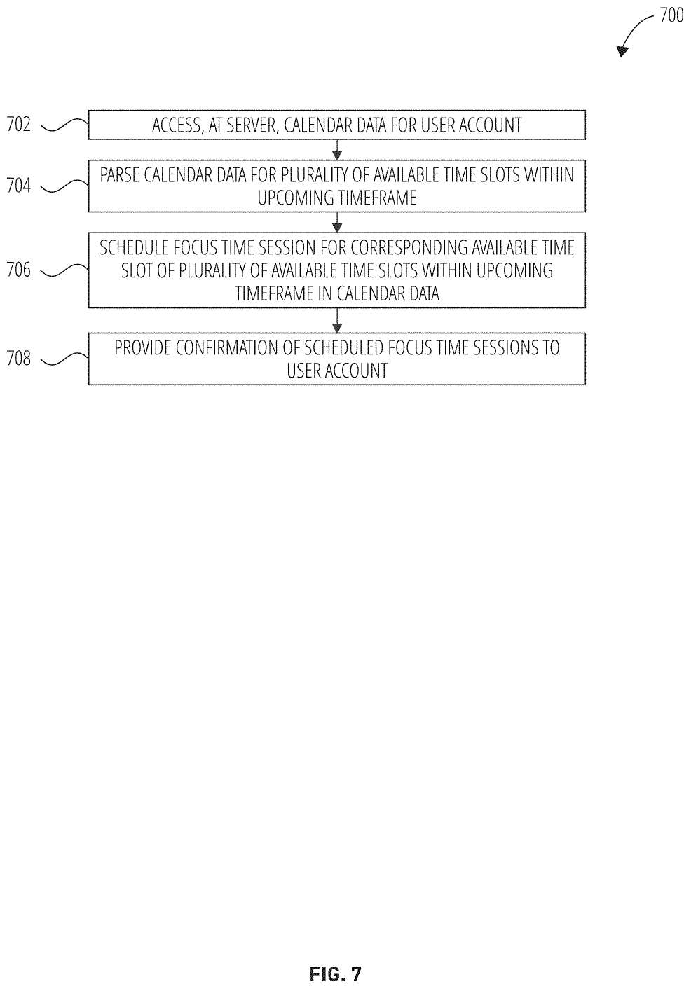

FIG. 8 illustrates an example of a graphical user interface of a presentation of scheduled focus times in accordance with one example embodiment.

FIG. 9 illustrates an example of a graphical user interface in accordance with one embodiment.

FIG. 10 illustrates an example of a graphical user interface in accordance with one embodiment.

FIG. 11 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a system for identifying and presenting available time slots in a calendar of a user account. Available time slots may refer to dates and times free of events (e.g., no appointments or meetings) on a calendar of a user account. The time slots may be identified in blocks of time such as, for example, at least two-hour blocks. These contiguous available time slots may also be referred to as “focus time”, “focus time session”, or “do not disturb time.” The focus time protects an enterprise user's time at work by reserving time for them to work uninterrupted and undistracted on his/her task or project. These focus time sessions are blocked on the use's calendar and can prevent the user from scheduling meetings conflicting with the scheduled focus time. In one example embodiment, a focus time session differs from a conventional meeting request because the blocked focus session does not include any invitees (or only include the user as an invitee). In another example embodiment, the focus time session may be associated with another calendar account (that is different from the default enterprise calendar account) of the user.

In one example embodiment, a server storing the calendar data identifies available time blocks (also referred to as open blocks) from the calendar of the user account on a weekly basis. The server generates a notification in a calendar application of the user account. The notification indicates scheduled focus time on his/her calendar for an upcoming week. In one example, the user accesses the notification using an email application on a client device of the user. The calendar application may display the open blocks and scheduled times on the calendar of the user. The calendar application may include an interactive tool (e.g., extensions or plug-in) that allows the user to see the open blocks on his/her calendar and schedule focus time for the upcoming week. Upon one click in the calendar application, the interactive tool identifies available times during the upcoming week and automatically books the focus time for the upcoming week. In another example, notifications (from the calendar application, email application, and other applications) are automatically silenced on the user's device for the duration of a focus time.

For example, with one click, the interactive tool blocks out 1-2 hours of focus time every working day on a user's calendar. The interactive tool prioritizes morning hours as some studies have shown that short-term memory peaks in the morning and attempts to book up to 2 hours to prevent users' focus from being fragmented by meetings. When the interactive tool is initially triggered, the interactive tool books focus time on every day for the remainder of the current week and upcoming week; the interactive tool then runs every weekend to book time for week t+1 (for example: if the function is triggered on Wednesday March 13, the interactive tool will initially book focus time daily from March 13 through Friday, March 22; then on Sunday, March 17 it will automatically book time through Friday, March 29, and so on).

In one example embodiment, the present application describes a system and method for updating calendar data. A server accesses calendar data for a user account and parses the calendar data for a plurality of available time slots within an upcoming timeframe. The server schedules a focus time session for a corresponding available time slot of the plurality of available time slots within the upcoming timeframe in the calendar data. A confirmation of the scheduled focus time sessions is provided to the user account.

As a result, one or more of the methodologies described herein facilitate solving the technical problem of identifying available time slots and securing those available time slots via multiple steps. The presently described tool provides an improvement to an operation of the functioning of a computer by providing faster calendar operations, increased scheduling flexibility, and smaller memory requirements. As such, one or more of the methodologies described herein may obviate a need for certain efforts or computing resources. Examples of such computing resources include processor cycles, network traffic, memory usage, data storage capacity, power consumption, network bandwidth, and cooling capacity.

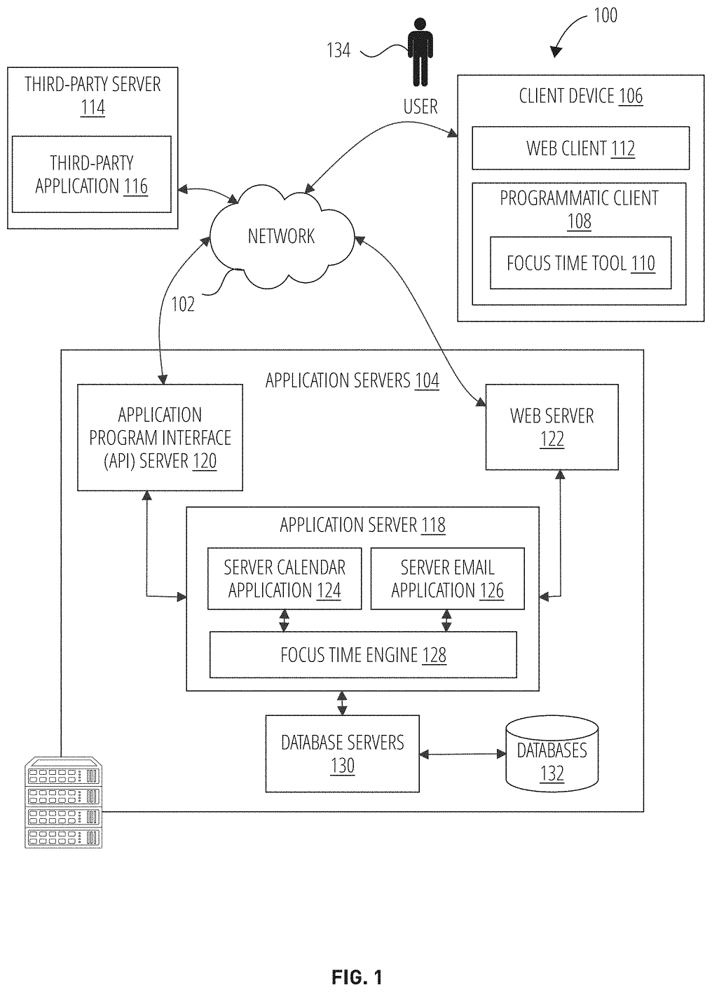

FIG. 1 is a diagrammatic representation of a network environment in which some example embodiments of the present disclosure may be implemented or deployed. One or more application servers 104 provide server-side functionality via a network 102 to a networked user device, in the form of a client device 106. A user 134 operates the client device 106. The client device 106 includes a web client 112 (e.g., a browser), a programmatic client 108 (e.g., an email/calendar application such as Microsoft Outlook™) that is hosted and executed on the client device 106. In one example embodiment, the programmatic client 108 includes a focus time tool 110 that enables the user to reserve or book available time slots from his/her calendar with one click.

For example, the focus time tool 110 identifies the available time slots and schedules focus time at the available time slots by using a graphical user interface of the programmatic client 108 to visualize the available time slots in the context of the programmatic client 108 (e.g., calendar application). For example, the available time slots may be presented in a graphical format, a listing format, a time table format, a grid format, or a weekly calendar format. The focus time tool 110 enables the user 134 to reserve (or automatically book) at least one of the identified available time slots (or a portion thereof) with one click. For example, the user 134 can reserve two-hours focus time every morning of the upcoming week based on the availability of the user 134. The focus time tool 110 may operate with the web client 112 and/or the programmatic client 108. In another example embodiment, the focus time tool 110 is part of the programmatic client 108 or web client 112. For example, the focus time tool 110 may operate as an extension or add-on to the web client 112 or the programmatic client 108.

An Application Program Interface (API) server 120 and a web server 122 provide respective programmatic and web interfaces to application servers 104. A specific application server 118 hosts a server calendar application 124, a server email application 126, and a focus time engine 128. The server calendar application 124, the server email application 126, and the focus time engine 128 include components, modules and/or applications.

The server calendar application 124 stores and updates calendar data associated with a user account of the user 134. The server email application 126 stores and updates email data associated with the user account of the user 134.

In one example embodiment, the focus time engine 128 communicates with the server calendar application 124 to identify available time slots from the calendar of the user 134. The focus time engine 128 accesses user preferences (e.g., morning focus time, focus time of a maximum of two-hours block, focus time of a minimum of one-hour block). The focus time engine 128 books or schedule focus time for the calendar of the user 134 during an upcoming timeframe (e.g., the remaining days of this week and next week) based on the user preferences. The server email application 126 communicates with the focus time tool 110 supported by the web server 122 to provide the identified available time slots to the programmatic client 108. In another example, the focus time engine 128 communicates the scheduled focus time to the server email application 126.

In one example, the web client 112 communicate with the focus time engine 128, server calendar application 124, and server email application 126 via the programmatic interface provided by the Application Program Interface (API) server 120.

The third-party application 116 may, for example, be another cloud storage system. The application server 118 is shown to be communicatively coupled to database servers 130 that facilitates access to an information storage repository or databases 132. In an example embodiment, the databases 132 includes storage devices that store information to be published and/or processed by at least one of the server calendar application 124, the server email application 126, and the focus time engine 128.

Additionally, a third-party application 116 executing on a third-party server 114, is shown as having programmatic access to the application server 118 via the programmatic interface provided by the Application Program Interface (API) server 120. For example, the third-party application 116, using information retrieved from the application server 118, may supports one or more features or functions on a website hosted by the third party.

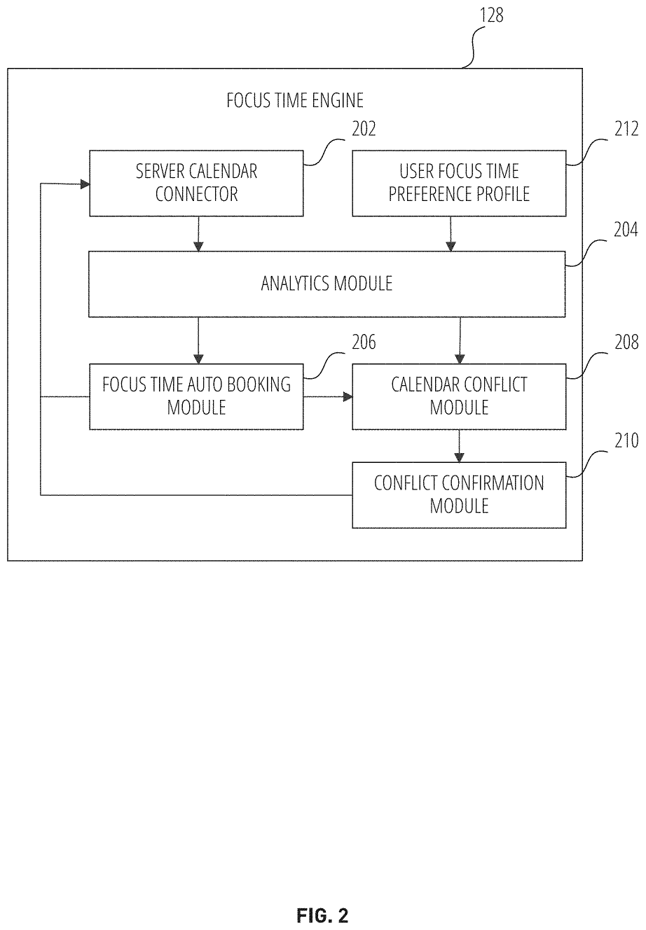

FIG. 2 is a block diagram illustrating a focus time engine in accordance with one example embodiment. The focus time engine 128 comprises a server calendar connector 202, an analytics module 204, a focus time auto booking module 206, a calendar conflict module 208, a conflict confirmation module 210, and a user focus time preference profile 212.

The server calendar connector 202 communicates with the server calendar application 124 to access and update (e.g., read/write) calendar data associated with the user account of the user 134. For example, the server calendar connector 202 retrieves a preset calendar range (e.g., an upcoming weekly schedule of the user 134, a current monthly schedule).

The user focus time preference profile 212 determines the focus time preference of the user 134. For example, the focus time preference may indicate that the user 134 prefers focus time for example, of at least two continuous hours (e.g., two-hour chunks), in the morning hours (e.g., between 6 am and 12 pm) every weekday.

The analytics module 204 receives the calendar data from the server calendar connector 202 and the focus time preference of the user 134 from user focus time preference profile 212. The analytics module 204 parses the calendar data and identifies available time slots based on the focus time preference within the upcoming timeframe (e.g., next week).

The focus time auto booking module 206 schedules focus time at the identified available time slots that meet the focus time preference. For example, the focus time auto booking module 206 receives a request from the user 134 to auto book focus time for the following week. The focus time auto booking module 206 instructs the server calendar connector 202 to update the calendar data of the user 134 based on the request. For example, the focus time auto booking module 206 instructs the server calendar connector 202 to book or block out the available time slots in the calendar of the user 134. The server calendar connector 202 communicates with the server calendar application 124 to instruct the server calendar application 124 to update the calendar data of the user 134.

The calendar conflict module 208 determines whether a meeting request received by the server calendar application 124 conflicts with a scheduled focus time booked by focus time auto booking module 206. For example, the user 134 may receive a meeting request that conflicts with one of the scheduled focus time for next week. The calendar conflict module 208 generates a confirmation request to the user 134. The confirmation request may query the user 134 whether to reschedule the meeting request or the scheduled focus time. In another example, the confirmation request may provide the user 134 with the option to reschedule the conflicted focus time to another available time slot. The calendar conflict module 208 receives a confirmation response (e.g., reschedule the meeting request or the scheduled focus time) from the user 134 and communicates a corresponding request (e.g., reschedule the meeting request or the scheduled focus time) to the server calendar connector 202.

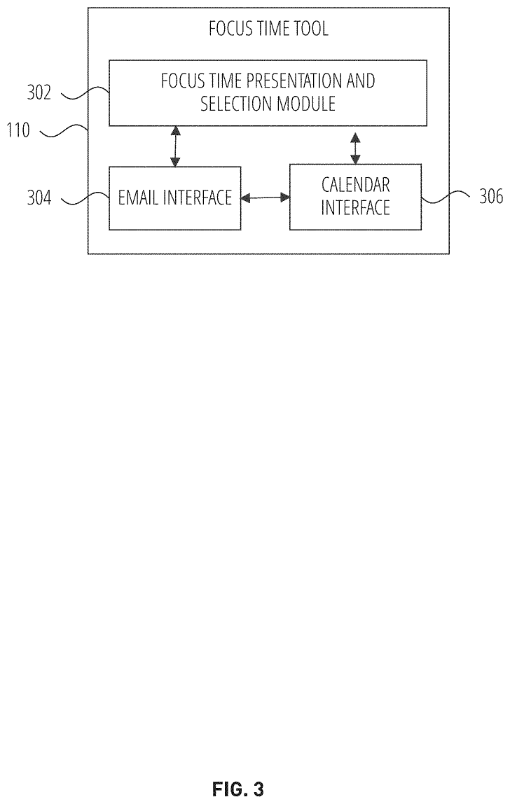

FIG. 3 is a block diagram illustrating a focus time tool 110 in accordance with one example embodiment. The focus time tool 110 includes a focus time presentation and selection module 302, an email interface 304, and a calendar interface 306. The focus time presentation and selection module 302 communicates with the email interface 304 and the calendar interface 306.

The focus time presentation and selection module 302 accesses the email from the focus time engine 128 via the email interface 304. The focus time presentation and selection module 302 presents the available time slots from the email. In another example embodiment, the focus time presentation and selection module 302 may visually present the available time slots in many ways (e.g., via cards, via other pop up dialog boxes, in a body of an email message).

The focus time presentation and selection module 302 further enables the user 134 to select at least one of the available time slots with one click. For example, the focus time presentation and selection module 302 identifies a selected time slot based on one click (e.g., click on “schedule focus time for next week” button) from the user 134. The focus time presentation and selection module 302 communicates the selected time slot via the email interface 304, the calendar interface 306, or via other communication means to the focus time engine 128.

In another example embodiment, the focus time presentation and selection module 302 may access calendar data from the server calendar application 124 via the calendar interface 306. The focus time presentation and selection module 302 may display the selected focus time within the context of the calendar data (e.g., display within a calendar or table format of the server calendar application 124 or the programmatic client 108).

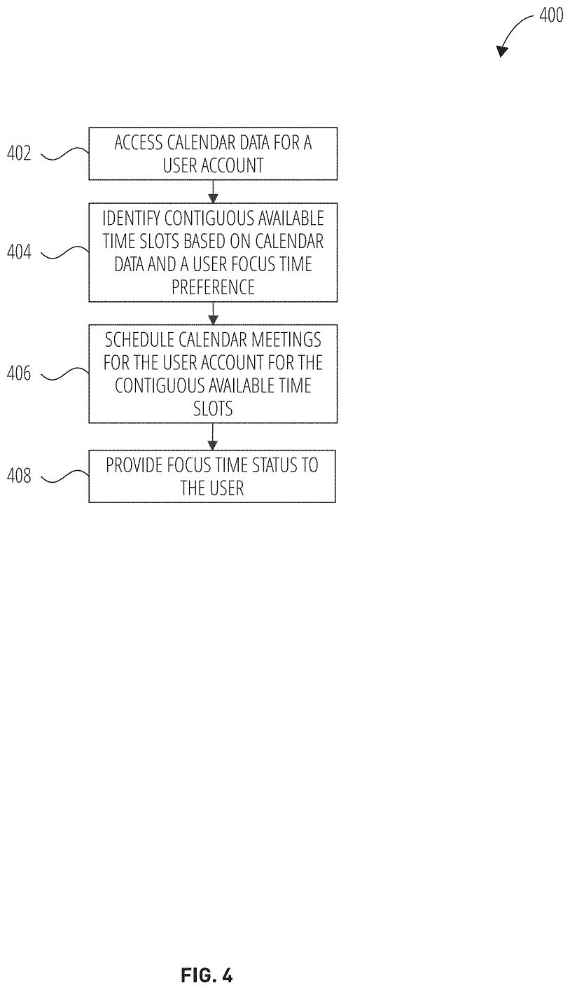

FIG. 4 is a flow diagram illustrating a method 400 for scheduling focus time in accordance with one example embodiment. Operations in the method 400 may be performed by the focus time engine 128, using components (e.g., modules, engines) described above with respect to FIG. 2. Accordingly, the method 400 is described by way of example with reference to the focus time engine 128. However, it shall be appreciated that at least some of the operations of the method 400 may be deployed on various other hardware configurations or be performed by similar components residing elsewhere. For example, some of the operations may be performed at the focus time tool 110.

At block 402, the focus time engine 128 accesses calendar data for a user account (e.g., user account of user 134). At block 404, the focus time engine 128 identifies contiguous available time slots based on the calendar data and a user focus time preference (e.g., minimum of a one-hour block and a maximum of a two-hour block between Sam and noon every weekday morning). At block 406, the focus time engine 128 schedules calendar meetings (scheduled focus time) for the user account for the contiguous available time slots. At block 408, the focus time engine 128 provides focus time status to the user. For example, the focus time status may indicate how many days the user 134 has kept their booked focus time the prior week, whether meetings were scheduled over the scheduled focus time, and whether the user 134 allowed themselves to be interrupted by emails or other non-work-related activities during that the scheduled focus time.

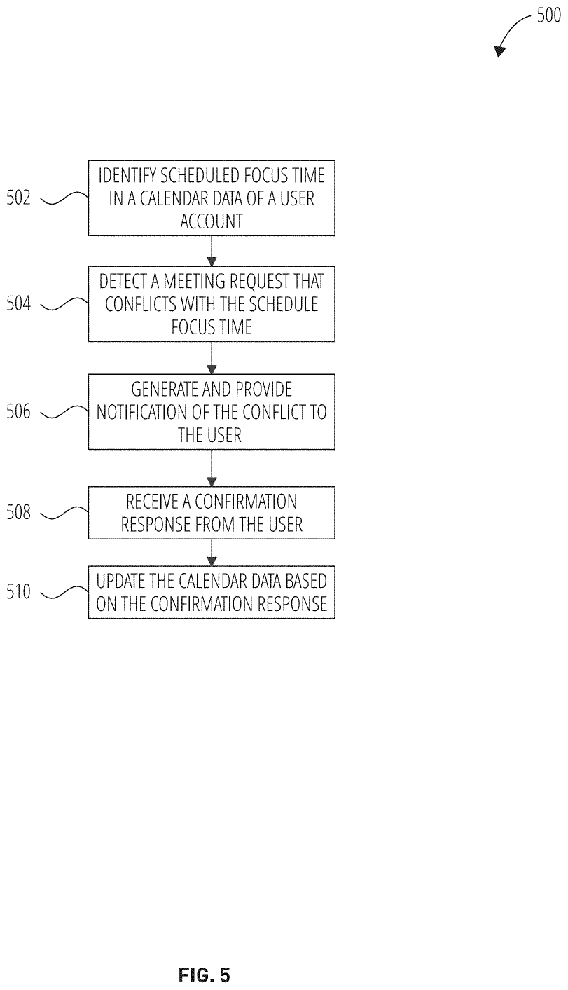

FIG. 5 is a flow diagram illustrating a method 500 for confirming focus time in accordance with one example embodiment. Operations in the method 500 may be performed by the focus time engine 128, using components (e.g., modules, engines) described above with respect to FIG. 2. Accordingly, the method 500 is described by way of example with reference to the focus time engine 128. However, it shall be appreciated that at least some of the operations of the method 500 may be deployed on various other hardware configurations or be performed by similar components residing elsewhere. For example, some of the operations may be performed at the focus time tool 110.

In block 502, the focus time auto booking module 206 identifies scheduled focus time in a calendar data of a user account. At block 504, the calendar conflict module 208 detects a meeting request that conflicts with the scheduled focus times. At block 506, the conflict confirmation module 210 generates and provides notification of the conflict to the user 134. At block 508, the conflict confirmation module 210 receives a confirmation response from the user 134. At block 510, the conflict confirmation module 210 updates the calendar data based on the confirmation response.

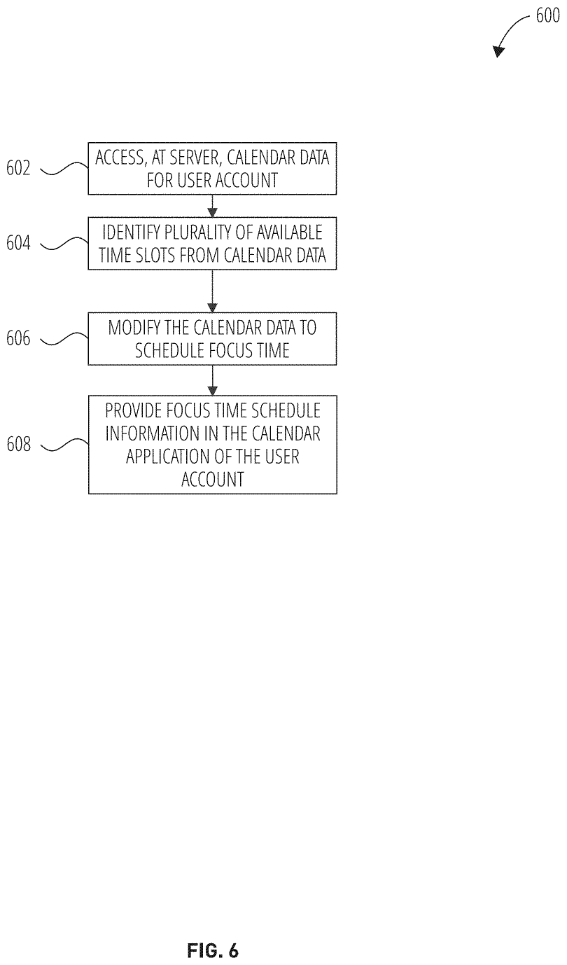

FIG. 6 illustrates is a flow diagram illustrating a method 600 for scheduling focus time in accordance with one example embodiment. Operations in the method 600 may be performed by the focus time engine 128, using components (e.g., modules, engines) described above with respect to FIG. 2. Accordingly, the method 500 is described by way of example with reference to the focus time engine 128. However, it shall be appreciated that at least some of the operations of the method 500 may be deployed on various other hardware configurations or be performed by similar components residing elsewhere. For example, some of the operations may be performed at the focus time tool 110.

At block 602, the focus time engine 128 accesses calendar data for a user account (e.g., user account of user 134). At block 604, the focus time engine 128 identifies contiguous available time slots based on the calendar data and a user focus time preference (e.g., minimum of a one-hour block and a maximum of a two-hour block between Sam and noon every weekday morning). At block 606, the focus time engine 128 modifies calendar data to schedule the focus time for the user account. At block 608, the focus time engine 128 provides focus time schedule information in a server calendar application 124 or the programmatic client 108 to the user 134.

In block 702, routine 700 accesses, at a server, calendar data for a user account. In block 704, routine 700 parses the calendar data for a plurality of available time slots within an upcoming timeframe. In block 706, routine 700 schedules a focus time session for a corresponding available time slot of the plurality of available time slots within the upcoming timeframe in the calendar data. In block 708, routine 700 provides a confirmation of the scheduled focus time sessions to the user account.

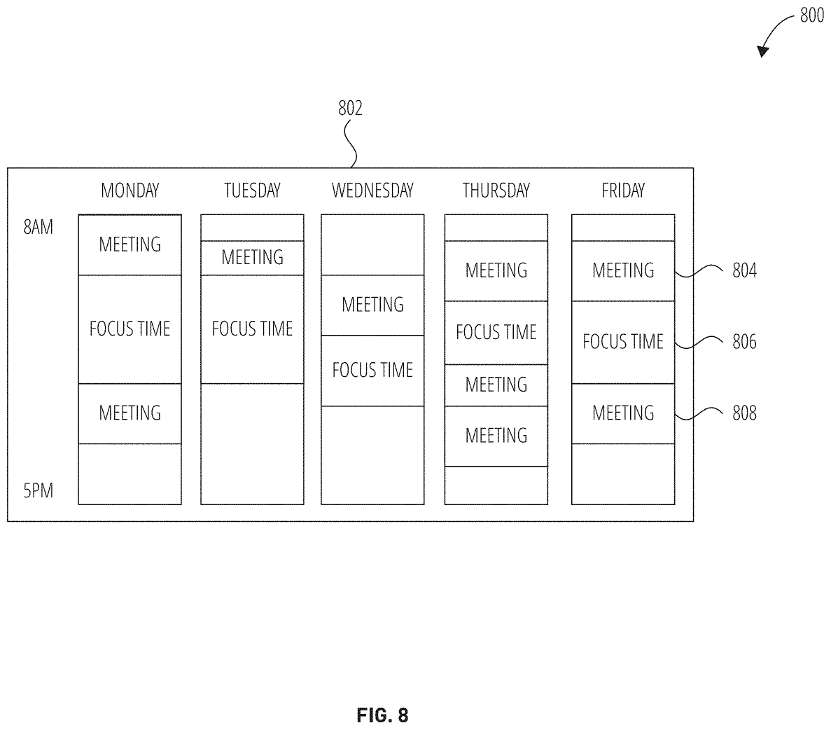

FIG. 8 illustrates an example of a graphical user interface 800 in accordance with one example embodiment. The graphical user interface 800 illustrates a weekly calendar 802 and focus time 806 scheduled in available slots (between already scheduled meetings such as meeting 804 and meeting 808 in the weekly calendar 802.

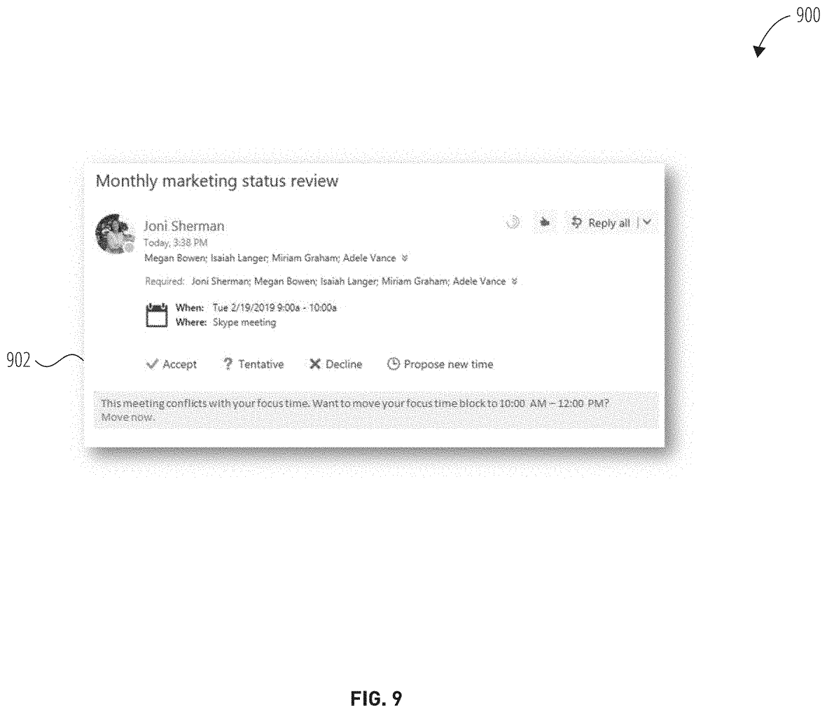

FIG. 9 illustrates an example of a dialog box 900 in accordance with one embodiment. The dialog box 900 illustrates an example of a confirmation request to the user in response to detecting a conflict.

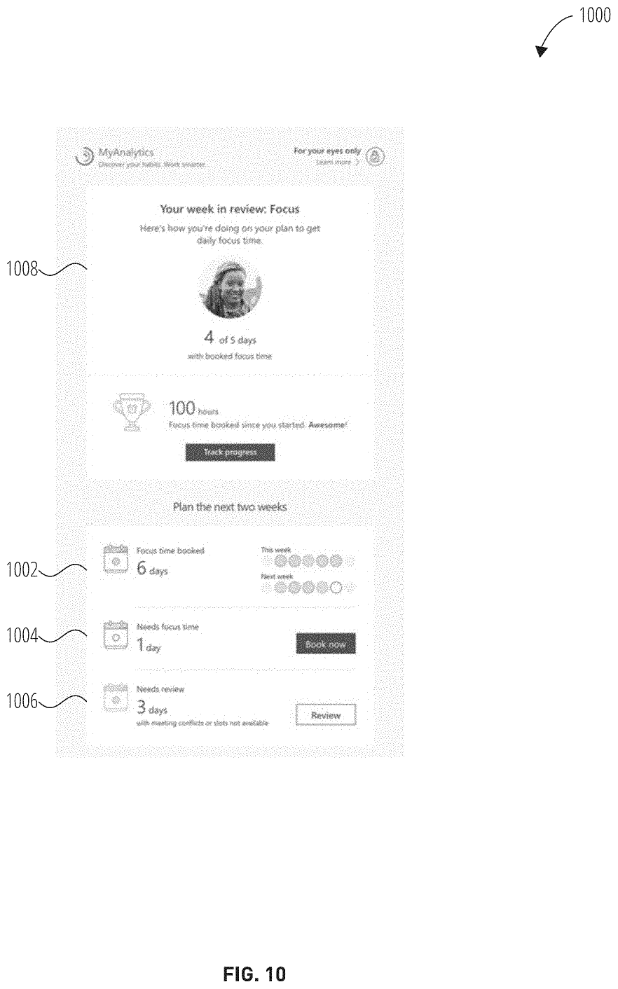

FIG. 10 illustrates an example of a graphical user interface of a status report 1000 in accordance with one embodiment. The status report 1000 indicates focus time progress 1008, focus time booked 1002, focus time suggestion 1004, and focus time conflicts 1006.

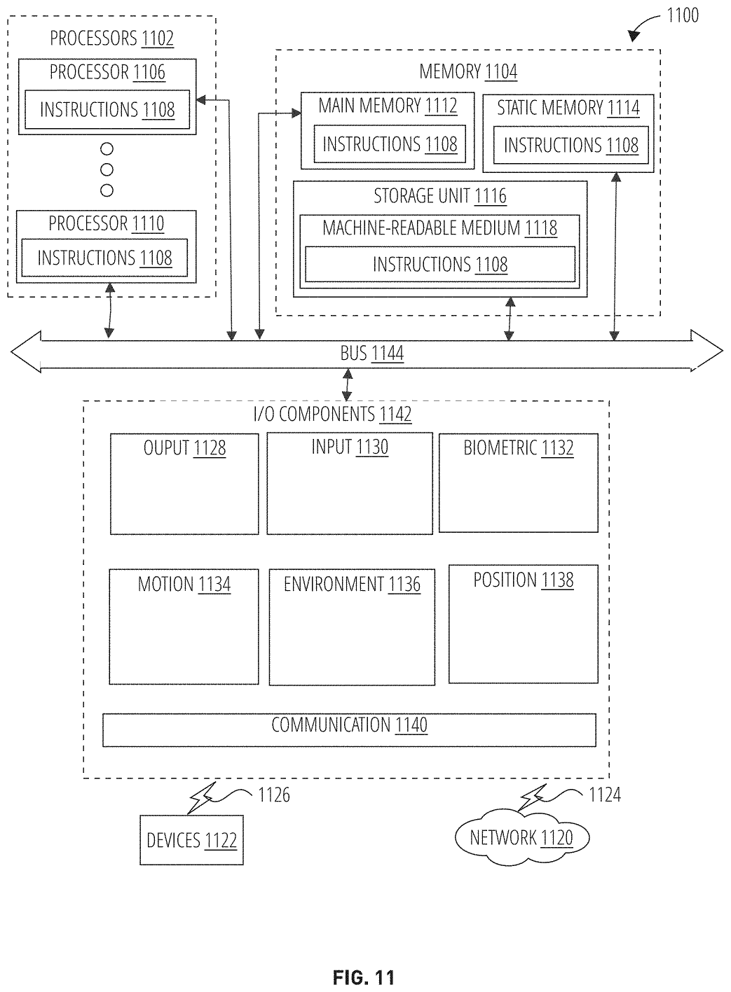

FIG. 11 is a diagrammatic representation of the machine 1100 within which instructions 1108 (e.g., software, a program, an application, an applet, an app, or other executable code) for causing the machine 1100 to perform any one or more of the methodologies discussed herein may be executed. For example, the instructions 1108 may cause the machine 1100 to execute any one or more of the methods described herein. The instructions 1108 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1108, sequentially or otherwise, that specify actions to be taken by the machine 1100. Further, while only a single machine 1100 is illustrated, the term “machine” shall also be taken to include a collection of machines that individually or jointly execute the instructions 1108 to perform any one or more of the methodologies discussed herein.

The machine 1100 may include processors 1102, memory 1104, and I/O components 1142, which may be configured to communicate with each other via a bus 1144. In an example embodiment, the processors 1102 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1106 and a processor 1110 that execute the instructions 1108. The term “processor” is intended to include multi-core processors that may comprise two or more independent processors (sometimes referred to as “cores”) that may execute instructions contemporaneously. Although FIG. 11 shows multiple processors 1102, the machine 1100 may include a single processor with a single core, a single processor with multiple cores (e.g., a multi-core processor), multiple processors with a single core, multiple processors with multiples cores, or any combination thereof.

The memory 1104 includes a main memory 1112, a static memory 1114, and a storage unit 1116, both accessible to the processors 1102 via the bus 1144. The main memory 1104, the static memory 1114, and storage unit 1116 store the instructions 1108 embodying any one or more of the methodologies or functions described herein. The instructions 1108 may also reside, completely or partially, within the main memory 1112, within the static memory 1114, within machine-readable medium 1118 within the storage unit 1116, within at least one of the processors 1102 (e.g., within the processor's cache memory), or any suitable combination thereof, during execution thereof by the machine 1100.

The I/O components 1142 may include a wide variety of components to receive input, provide output, produce output, transmit information, exchange information, capture measurements, and so on. The specific I/O components 1142 that are included in a particular machine will depend on the type of machine. For example, portable machines such as mobile phones may include a touch input device or other such input mechanisms, while a headless server machine will likely not include such a touch input device. It will be appreciated that the I/O components 1142 may include many other components that are not shown in FIG. 11. In various example embodiments, the I/O components 1142 may include output components 1128 and input components 1130. The output components 1128 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1130 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1142 may include biometric components 1132, motion components 1134, environmental components 1136, or position components 1138, among a wide array of other components. For example, the biometric components 1132 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1134 include acceleration sensor components (e.g., accelerometer), gravitation sensor components, rotation sensor components (e.g., gyroscope), and so forth. The environmental components 1136 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1138 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1142 further include communication components 1140 operable to couple the machine 1100 to a network 1120 or devices 1122 via a coupling 1124 and a coupling 1126, respectively. For example, the communication components 1140 may include a network interface component or another suitable device to interface with the network 1120. In further examples, the communication components 1140 may include wired communication components, wireless communication components, cellular communication components. Near Field Communication (NFC) components, Bluetooth® components (e.g., Bluetooth® Low Energy), Wi-Fi® components, and other communication components to provide communication via other modalities. The devices 1122 may be another machine or any of a wide variety of peripheral devices (e.g., a peripheral device coupled via a USB).

Moreover, the communication components 1140 may detect identifiers or include components operable to detect identifiers. For example, the communication components 1140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as location via Internet Protocol (IP) geolocation, location via Wi-Fit, signal triangulation, location via detecting an NFC beacon signal that may indicate a particular location, and so forth.

The various memories (e.g., memory 1104, main memory 1112, static memory 1114, and/or memory of the processors 1102) and/or storage unit 1116 may store one or more sets of instructions and data structures (e.g., software) embodying or used by any one or more of the methodologies or functions described herein. These instructions (e.g., the instructions 1108), when executed by processors 1102, cause various operations to implement the disclosed embodiments.

The instructions 1108 may be transmitted or received over the network 1120, using a transmission medium, via a network interface device (e.g., a network interface component included in the communication components 1140) and using am one of a number of well-known transfer protocols (e.g., hypertext transfer protocol (HTTP)). Similarly, the instructions 1108 may be transmitted or received using a transmission medium via the coupling 1126 (e.g., a peer-to-peer coupling) to the devices 1122.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method comprising: accessing, at a server, calendar data for a user account; parsing the calendar data for a plurality of available time slots within an upcoming timeframe; scheduling a focus time session for a corresponding available time slot of the plurality of available time slots within the upcoming timeframe in the calendar data; and providing a confirmation of the scheduled focus time sessions to the user account.

Example 2 includes the subject matter of example 1, further comprising: detecting a meeting request for the user account; detecting that the meeting request conflicts with the scheduled focus time sessions; generating a confirmation query that indicates the conflicts to the user account; receiving a confirmation response in response to the confirmation query; and updating the calendar data for the user account based on the confirmation response.

Example 3 includes the subject matter of example 2, wherein the confirmation query indicates an option to reschedule a meeting request that conflicts with a scheduled focus time session to another available time slot from the calendar data of the user account, wherein the confirmation response indicates a confirmation to reschedule the meeting request that conflicts with the scheduled focus time session to another available time slot from the calendar data of the user account.

Example 4 includes the subject matter of example 2, wherein the confirmation query indicates an option to reschedule a scheduled focus time session that conflicts with the meeting request to another available time slot from the calendar data of the user account, wherein the confirmation response indicates a confirmation to reschedule the scheduled focus time session that conflicts with the meeting request to another available time slot from the calendar data of the user account.

Example 5 includes the subject matter of example 1, wherein parsing the calendar data further comprises: identifying a plurality of contiguous available time slots within a preset time range and within a preset date range of the upcoming timeframe, each contiguous available time slot having a duration of at least a preset number of minimum consecutive hours and a preset number of maximum consecutive hours.

Example 6 includes the subject matter of example 5, further comprising: adjusting the preset number of minimum consecutive hours based on a minimum available duration preference for the user account; and adjusting the preset number of maximum consecutive hours based on a maximum available duration preference for the user account.

Example 7 includes the subject matter of example 5, wherein the preset time range corresponds to a morning time range.

Example 8 includes the subject matter of example 1, wherein the parsing further comprises: periodically parsing the calendar data after the upcoming timeframe has elapsed.

Example 9 includes the subject matter of example 1, wherein providing the confirmation of the scheduled focus time sessions further comprises: causing a graphical representation of the scheduled focus time sessions in a graphical display of a weekly calendar provided by a calendar application corresponding to the user account.

Example 10 includes the subject matter of example 1, further comprising: determining whether any of the scheduled focus time sessions have been canceled or rescheduled; and generating a weekly report that indicates whether any of the scheduled focus time sessions have been canceled or rescheduled and whether the user has operated an email application on a client device of the calendar application during the scheduled focus time sessions, after the upcoming timeframe has elapsed.

What is claimed is:

1. A computer-implemented method comprising:
accessing, at a server, calendar data for a user account;
parsing the calendar data for a plurality of available time slots within an upcoming timeframe;
scheduling a focus time session for a corresponding available time slot of the plurality of available time slots within the upcoming timeframe in the calendar data; and
providing a confirmation of the scheduled focus time sessions to the user account.

2. The computer-implemented method of claim 1, further comprising:
detecting a meeting request for the user account;
detecting that the meeting request conflicts with the scheduled focus time sessions;
generating a confirmation query that indicates the conflicts to the user account;
receiving a confirmation response in response to the confirmation query; and
updating the calendar data for the user account based on the confirmation response.

3. The computer-implemented method of claim 2, wherein the confirmation query indicates an option to reschedule a meeting request that conflicts with a scheduled focus time session to another available time slot from the calendar data of the user account,
wherein the confirmation response indicates a confirmation to reschedule the meeting request that conflicts with the scheduled focus time session to another available time slot from the calendar data of the user account.

4. The computer-implemented method of claim 2, wherein the confirmation query indicates an option to reschedule a scheduled focus time session that conflicts with the meeting request to another available time slot from the calendar data of the user account,
wherein the confirmation response indicates a confirmation to reschedule the scheduled focus time session that conflicts with the meeting request to another available time slot from the calendar data of the user account.

5. The computer-implemented method of claim 1, wherein parsing the calendar data further comprises:
identifying a plurality of contiguous available time slots within a preset time range and within a preset date range of the upcoming timeframe, each contiguous available time slot having a duration of at least a preset number of minimum consecutive hours and a preset number of maximum consecutive hours.

6. The computer-implemented method of claim 5, further comprising:
adjusting the preset number of minimum consecutive hours based on a minimum available duration preference for the user account; and
adjusting the preset number of maximum consecutive hours based on a maximum available duration preference for the user account.

7. The computer-implemented method of claim 5, wherein the preset time range corresponds to a morning time range.

8. The computer-implemented method of claim 1, wherein the parsing further comprises:
periodically parsing the calendar data after the upcoming timeframe has elapsed.

9. The computer-implemented method of claim 1, wherein providing the confirmation of the scheduled focus time sessions further comprises:
causing a graphical representation of the scheduled focus time sessions in a graphical display of a weekly calendar provided by a calendar application corresponding to the user account.

10. The computer-implemented method of claim 1, further comprising:
determining whether any of the scheduled focus time sessions have been canceled or rescheduled; and
generating a weekly report that indicates whether any of the scheduled focus time sessions have been canceled or rescheduled and whether the user has operated an email application on a client device of the calendar application during the scheduled focus time sessions, after the upcoming timeframe has elapsed.

11. A computing apparatus, the computing apparatus comprising:
a processor; and
a memory storing instructions that, when executed by the processor, configure the apparatus to:
access, at a server, calendar data for a user account;
parse the calendar data for a plurality of available time slots within an upcoming timeframe;
schedule a focus time session for a corresponding available time slot of the plurality of available time slots within the upcoming timeframe in the calendar data; and
provide a confirmation of the scheduled focus time sessions to the user account.

12. The computing apparatus of claim 11, wherein the instructions further configure the apparatus to:
detect a meeting request for the user account;
detect that the meeting request conflicts with the scheduled focus time sessions;
generate a confirmation query that indicates the conflicts to the user account;
receive a confirmation response in response to the confirmation query; and
update the calendar data for the user account based on the confirmation response.

13. The computing apparatus of claim 12, wherein the confirmation query indicates an option to reschedule a meeting request that conflicts with a scheduled focus time session to another available time slot from the calendar data of the user account,
wherein the confirmation response indicates a confirmation to reschedule the meeting request that conflicts with the scheduled focus time session to another available time slot from the calendar data of the user account.

14. The computing apparatus of claim 12, wherein the confirmation query indicates an option to reschedule a scheduled focus time session that conflicts with the meeting request to another available time slot from the calendar data of the user account,
wherein the confirmation response indicates a confirmation to reschedule the scheduled focus time session that conflicts with the meeting request to another available time slot from the calendar data of the user account.

15. The computing apparatus of claim 11, wherein parsing the calendar data further comprises:
identify a plurality of contiguous available time slots within a preset time range and within a preset date range of the upcoming timeframe, each contiguous available time slot having a duration of at least a preset number of minimum consecutive hours and a preset number of maximum consecutive hours.

16. The computing apparatus of claim 15, wherein the instructions further configure the apparatus to:
adjust the preset number of minimum consecutive hours based on a minimum available duration preference for the user account; and
adjust the preset number of maximum consecutive hours based on a maximum available duration preference for the user account.

17. The computing apparatus of claim 15, wherein the preset time range corresponds to a morning time range.

18. The computing apparatus of claim 11, wherein the parsing further comprises:
periodically parse the calendar data after the upcoming timeframe has elapsed.

19. The computing apparatus of claim 11, wherein providing the confirmation of the scheduled focus time sessions further comprises:
cause a graphical representation of the scheduled focus time sessions in a graphical display of a weekly calendar provided by a calendar application corresponding to the user account.

20. A non-transitory computer-readable storage medium, the computer-readable storage medium including instructions that when executed by a computer, cause the computer to:
access, at a server, calendar data for a user account;
parse the calendar data for a plurality of available time slots within an upcoming timeframe;
schedule a focus time session for a corresponding available time slot of the plurality of available time slots within the upcoming timeframe in the calendar data; and
provide a confirmation of the scheduled focus time sessions to the user account.
